(19) United States
(12) Patent Application Publication
(10) Pub. No.: US 2026/0338023 A1
(43) Pub. Date: Oct. 29, 2026

(54) POWERED DOOR ACTUATOR WITH BELT DRIVE AND METHOD OF OPERATION THEREOF

(71) Applicant: MAGNA CLOSURES INC., Newmarket (CA)

(72) Inventors: Francesco Cumbo, Pisa (IT); Tommaso Cavaliere, Newmarket (CA)

(73) Assignee: MAGNA CLOSURES INC., Newmarket (CA)

(21) Appl. No.: 19/644,589

(22) Filed: Apr. 10, 2026

Related U.S. Application Data
(60) Provisional application No. 63/794,500, filed on Apr. 25, 2025.

(51) Int. Cl. E05F 15/627; E05F 15/40; E05F 15/622

(52) U.S. Cl. CPC E05F 15/627; E05F 15/40; E05F 15/622; E05Y 2900/531

(57) ABSTRACT

A power closure member actuation system for moving a closure member of a vehicle between an open position and a closed position is provided. The power closure member actuation system includes an external sensor disposed on the closure member and configured to detect motion of the closure member. The power closure member actuation system additionally includes an actuator for moving the closure member and an internal sensor in the actuator configured to detect internal motion of the actuator. The power closure member actuation system also includes a controller in communication with the actuator and the internal sensor and the external sensor and configured to detect motion of the closure member using the external sensor on the closure member to control the actuator for moving the closure member. The controller also detects the internal motion of the actuator using the internal sensor in the actuator to control the actuator.

### CROSS-REFERENCE TO RELATED APPLICATION

This utility application claims the benefit of U.S. Provisional Application No. 63/794,500 filed Apr. 25, 2025. The entire disclosure of the above application is incorporated herein by reference.

### FIELD

The present disclosure relates generally to closure member systems for motor vehicles and, more particularly, to a power closure member actuation system for moving a closure member, such as a vehicle door, relative to a vehicle body between an open position and a closed position.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

As a further advancement, power closure member actuation systems have been developed. For passenger doors, like those described above, the power closure member system can function to automatically swing the passenger door about its pivot axis between the open and closed positions, to assist the user as he or she moves the passenger door, and/or to pop out or present the passenger door to the user. Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Schuering et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

While such power closure member actuation systems function satisfactorily for their intended purpose, one recognized drawback relates to control delays of the power assist due to factors such as internal resistance in the power-operated device. Such delays can adversely affect the user’s experience with system operation.

In view of the above, there remains a need to develop alternative power closure member actuation systems and corresponding methods of operation which address and overcome limitations and drawbacks associated with known power closure member actuation systems as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure member actuation system for moving a closure member of a vehicle between an open position and a closed position relative to a vehicle body. The power closure member actuation system includes an external sensor disposed on the closure member and configured to detect motion of the closure member. The power closure member actuation system additionally includes an actuator for moving the closure member and an internal sensor in the actuator configured to detect internal motion of the actuator. The power closure member actuation system also includes a controller in communication with the actuator and the internal sensor and the external sensor and configured to detect motion of the closure member using the external sensor on the closure member to control the actuator for moving the closure member. The controller is also configured to detect the internal motion of the actuator using the internal sensor in the actuator to control the actuator.

In a related aspect, the controller is further configured to stop controlling the actuator using the external sensor on the closure member when the internal motion is detected using the internal sensor in the actuator, and start controlling the actuator using the internal sensor in the actuator when the internal motion is detected using the internal sensor in the actuator.

In a related aspect, the actuator includes an electric motor operably coupled to an extendable linkage, the internal sensor in the actuator is configured to detect motion in a kinematic chain disposed between the extendable linkage and the internal sensor, the kinematic chain includes a flexible element configured to flex in response to a user moving the closure member prior to the internal sensor detecting motion of the kinematic chain, the external sensor is configured to detect motion of the kinematic chain, and the controller is further configured to: detect motion of the kinematic chain using the external sensor temporally prior to detecting motion of the kinematic chain using the internal sensor; control the electric motor of the actuator using the external sensor prior to the internal sensor detecting motion of the kinematic chain; stop controlling of the electric motor of the actuator using the external sensor subsequent to the internal sensor detecting motion of the kinematic chain; and start controlling the electric motor of the actuator using the internal sensor subsequent to the internal sensor detecting motion of the kinematic chain.

It is another aspect of the disclosure to provide a method of controlling movement of a closure member of a vehicle between open and closed positions relative to a vehicle body using a power closure member actuation system. The method includes the step of using an external sensor on the closure member to detect motion of the closure member to control an actuator for moving the closure member. The method also includes the step of using an internal sensor in the actuator to detect internal motion of the actuator to control the actuator.

It is a further aspect of the disclosure to provide another power closure member actuation system for moving a closure member of a vehicle between an open position and a closed position relative to a vehicle body. The power closure member actuation system includes an actuator coupled to the closure member and the vehicle body and configured to move the closure member relative to the vehicle body. The actuator includes a drive mechanism operably coupled to the closure member and an electric motor coupled to the drive mechanism by a flexible element configured to allow flex between a drive shaft of the electric motor and the drive mechanism as the closure member is moved by a user. The drive mechanism and the flexible element comprise a kinematic chain. The power closure member actuation system additionally includes an external sensor separate from the actuator and coupled to the closure member and configured to detect motion of the closure member. The power closure member actuation system also includes a controller in communication with the actuator and the external sensor. The controller is configured to determine the closure member is moved manually by the user using the external sensor including movement enabled by the flex. The controller is also configured to control the actuator to move the closure member based on the movement of the closure member by the user detected by the external sensor.

In a related aspect, the drive shaft of the electric motor is rotatable about a drive shaft axis, the power closure member actuation system further includes an internal sensor coupled to the drive shaft of the electric motor and in communication with the controller and configured to detect rotation of the drive shaft and wherein the controller is further configured to determine the closure member is moved manually by the user using the external sensor and control the actuator to move the closure member temporally prior to detecting the rotation of the drive shaft of the electric motor using the internal sensor in response to the user manually moving the closure member.

It is an additional aspect of the disclosure to provide an actuator for a closure member of a vehicle movable relative to a vehicle body of the vehicle between an open position and a closed position. The actuator includes a drive mechanism operably coupled to the closure member for moving the closure member. The actuator additionally includes an electric motor including a drive shaft rotatable about a drive shaft axis. The actuator also includes a flexible element coupling the drive shaft of the electric motor and the drive mechanism and configured to allow flex between the drive shaft and the drive mechanism as the closure member is moved by a user. The drive mechanism and the flexible element comprise a kinematic chain.

It is another aspect of the disclosure to provide a method of controlling movement of a closure member of a vehicle between open and closed positions relative to a vehicle body using a power closure member actuation system. The method includes the step of providing an actuator for the closure member with an extendable linkage. Next, providing an internal sensor in the actuator. In addition, the method includes the step of providing a kinematic chain between the extendable linkage and the internal sensor. The method proceeds with the step of providing a flexible element as part of the kinematic chain. The method continues by allowing the flexible element to flex in response to a user moving the closure member prior to the internal sensor detecting motion of the kinematic chain. The next step of the method is providing an external sensor external to the actuator. The method additionally includes the step of detecting motion of the kinematic chain using the external sensor temporally prior to detecting motion of the kinematic chain using the internal sensor. The method further includes the step of controlling an electric motor of the actuator using the external sensor prior to the internal sensor detecting motion of the kinematic chain. The method proceeds with the step of stopping controlling of the electric motor of the actuator using the external sensor subsequent to the internal sensor detecting motion of the kinematic chain. The method also includes the step of starting controlling the electric motor of the actuator using the internal sensor subsequent to the internal sensor detecting motion of the kinematic chain.

It is yet another aspect of the disclosure to provide another method of controlling movement of a closure member of a vehicle between open and closed positions relative to a vehicle body using a power closure member actuation system. The method includes the step of detecting motion of the closure member using a closure member accelerometer on the closure member. The method proceeds with the step of controlling an actuator for moving the closure member using the closure member accelerometer on the closure member. The method proceeds with the step of detecting internal motion of the actuator using an internal sensor in the actuator. The method continues by stopping controlling the actuator using the closure member accelerometer on the closure member when the internal motion is detected using the internal sensor in the actuator. The method also includes the step of starting controlling the actuator using the internal sensor in the actuator when the internal motion is detected using the internal sensor in the actuator.

In a related aspect, the method includes using an external sensor on the closure member to detect motion of the closure member to control an actuator for moving the closure member; and using an internal sensor in the actuator to detect internal motion of the actuator to control the actuator.

In a related aspect, the external sensor is a closure member accelerometer and the method further includes the steps of: stopping controlling the actuator using the closure member accelerometer on the closure member when the internal motion is detected using the internal sensor in the actuator; and starting controlling the actuator using the internal sensor in the actuator when the internal motion is detected using the internal sensor in the actuator.

In a related aspect, the method further includes the steps of: providing the actuator for the closure member with an extendable linkage; providing the internal sensor in the actuator; providing a kinematic chain between the extendable linkage and the internal sensor; providing a flexible element as part of the kinematic chain;allowing the flexible element to flex in response to a user moving the closure member prior to the internal sensor detecting motion of the kinematic chain; providing the external sensor external to the actuator; detecting motion of the kinematic chain using the closure member accelerometer temporally prior to detecting motion of the kinematic chain using the internal sensor; controlling an electric motor of the actuator using the closure member accelerometer prior to the internal sensor detecting motion of the kinematic chain; stopping controlling of the electric motor of the actuator using the closure member accelerometer subsequent to the internal sensor detecting motion of the kinematic chain; and starting controlling the electric motor of the actuator using the internal sensor subsequent to the internal sensor detecting motion of the kinematic chain.

In a related aspect, the method further includes the steps of: allowing flex between a drive shaft of an electric motor of the actuator and a drive mechanism of the actuator using a flexible element of the actuator as the closure member is moved by a user, the actuator coupled to the closure member and the vehicle body for moving the closure member relative to the vehicle body, the drive mechanism and the flexible element comprising a kinematic chain; determining the closure member is moved manually by the user using the external sensor separate from the actuator including movement enabled by the flex; and controlling the actuator to move the closure member based on the movement of the closure member by the user detected by the external sensor.

In a related aspect the method further includes the step of determining the closure member is moved manually by the user using the external sensor and controlling the actuator to move the closure member temporally prior to detecting rotation of the drive shaft of the electric motor using an internal position sensor in the actuator in response to the user manually moving the closure member.

In accordance with yet another aspect, there is provided a power-operated actuator mechanism for moving a closure member of a vehicle between an open position and a closed position relative to a vehicle body, the power closure member actuator including: a motor for extending and retracting an extensible member to move the closure member; a kinematic chain coupling the extensible member to the motor, the kinematic chain having a lost motion; and an internal sensor in the actuator configured to detect internal motion of the actuator when the lost motion is taken up; wherein the lost motion allows the extensible member to move during a manual motion of the closure member before the lost motion is taken up.

In a related aspect, the internal sensor is configured to detect motion of the motor after the lost motion is taken up.

In a related aspect, the kinematic chain includes a flexible element providing the lost motion, wherein the flexible element is configured to flex in response to a user manually moving the door.

In a related aspect, the flexible element is a belt, wherein the lost motion is provided by a flexing the belt.

In a related aspect, the internal sensor is configured to detect a motion imparted to the closure member by a user manually moving the closure member, wherein the internal sensor is configured to supply a motion signal to a controller, wherein the motor is electrically coupled to the controller and is configured to receive a motor signal from the controller generated using the motion signal.

In a related aspect, the internal sensor is configured to detect the motion imparted to the closure member by a user manually moving the closure member when the lost motion is taken up.

In a related aspect, the motor is configured to receive an actuation signal generated by the controller before the lost motion is taken up.

In a related aspect, the motor is configured to receive an actuation signal generated by a controller before the lost motion is taken up and before the internal sensor detects internal motion.

In a related aspect, the motor is actuated by an actuation signal generated by a controller before the lost motion is taken up is generated based on the controller receiving another motion signal from an external sensor.

In a related aspect, the kinematic chain includes a nut coupled to the extensible member; a lead screw in threaded engagement with the nut, the lead screw configured to cause translation of the nut along the lead screw during rotation of the lead screw; a flexible belt adapted to rotate the lead screw, the flexible belt coupled to a motor shaft of the motor.

In a related aspect, a power-operated actuator mechanism operated by a controller for moving a closure member of a vehicle between an open position and a closed position relative to a vehicle body is provided. The controller is in communication with an external sensor configured to output an external sensor signal to the controller. The power closure member actuator includes a motor having a rotatable motor shaft. The motor is for extending and retracting an extensible member to move the closure member. The motor is configured to receive a command signal from the controller for rotating the rotatable motor shaft. A kinematic chain couples the extensible member to the motor. The kinematic chain is configured to rotate the motor shaft in response to a user manually moving the door. The kinematic chain is configured to extend and retract the extensible member in response to the motor receiving the command signal. An internal sensor in the actuator is configured to detect internal motion of the motor shaft in response to a user manually moving the closure member and to output an internal sensor signal to the controller. The motor is configured to receive the command signal generated by a controller using the external sensor signal for causing rotation of the motor shaft before the internal sensor detects internal motion of the motor shaft.

In a related aspect, the kinematic chain comprises lost motion. The motor is configured to receive the command signal generated by a controller using the external sensor signal for causing rotation of the motor shaft before the lost motion is taken up.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective inner side view of a closure member of a motor vehicle, with various components removed for clarity purposes only, in relation to a portion of the vehicle body and which is equipped with the power closure member actuation system according to aspects of the disclosure;

FIG. 2 shows possible movement of the closure member between the open position and the closed position and illustrates the amount of the movement of the closure member that may be allowed before a sensor of other known actuators detect movement of the closure member by the user;

FIG. 3 shows an example actuator that allows movement of the closure member in response to external forces to be detected more quickly compared to other known actuators according to aspects of the disclosure;

FIG. 4 is a simplified diagram of the actuator of FIG. 3 connected to the closure member while a user applies a force on the closure member according to aspects of the disclosure; and

FIGS. 5-7 illustrate steps of a method of controlling movement of a closure member of a vehicle between open and closed positions relative to a vehicle body using a power closure member actuation system according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system and method of operation constructed in accordance with the teachings of the present disclosure will now be disclosed. The example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

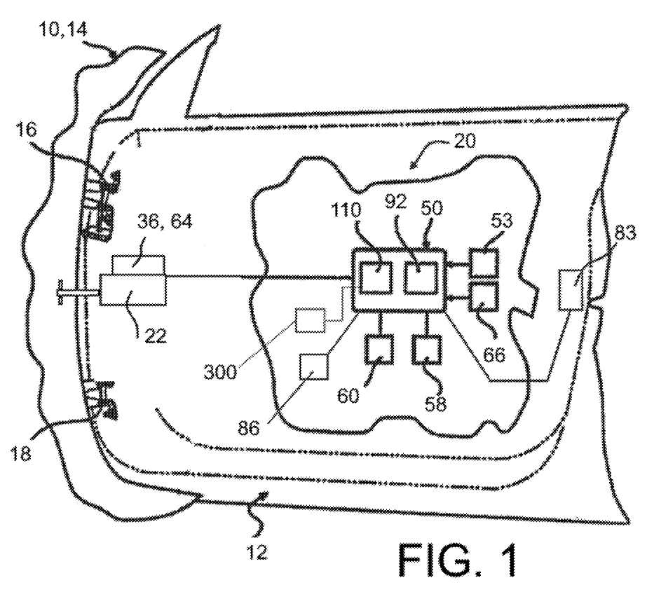

Referring initially to FIG. 1, a passenger door 12 of an example motor vehicle 10 or also referred to as an exemplary closure member 12, is shown pivotally mounted to a vehicle body 14 of the motor vehicle 10 via an upper door hinge 16 and a lower door hinge 18. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10.

The power closure member actuation system 20 is operable for controllably pivoting vehicle door 12 relative to vehicle body 14 between an open position and a closed position. The actuator 22 is coupled to the closure member (e.g., vehicle door 12) and the vehicle body 14. The actuator 22 is configured to move the closure member 12 relative to the vehicle body 14.

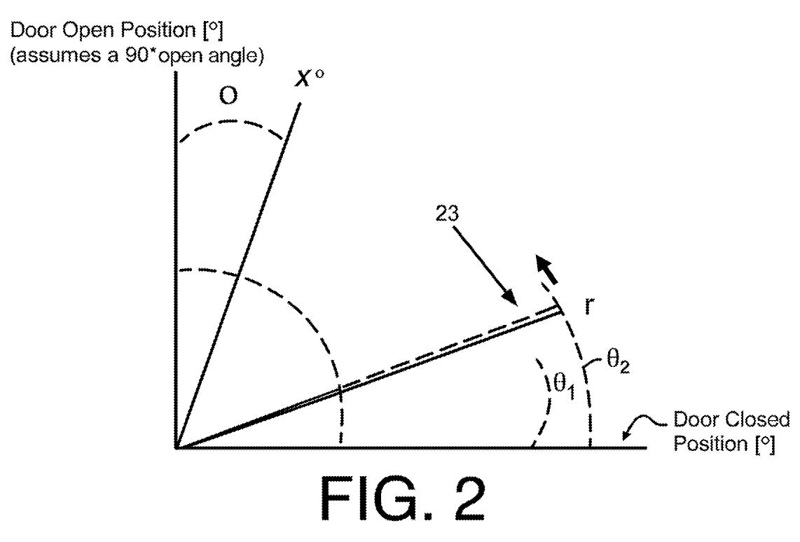

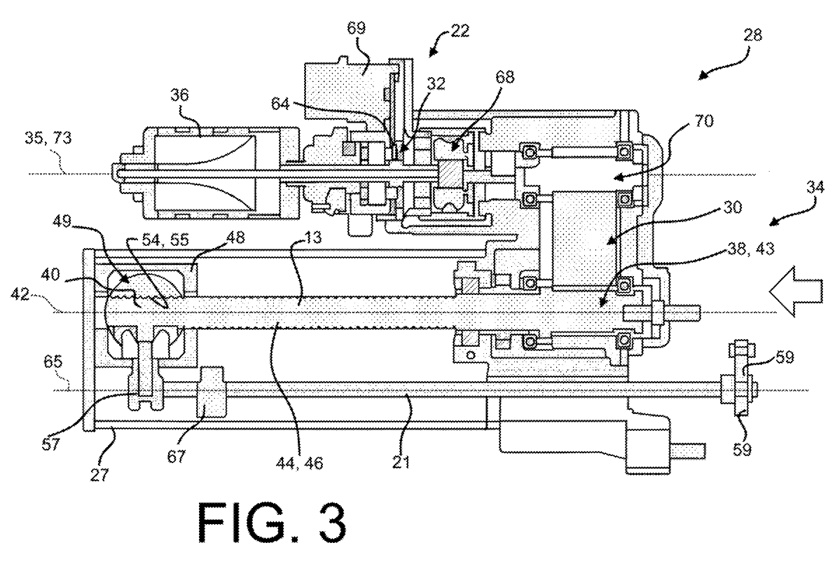

In other known actuators conventional (i.e., variations of actuator 22), small movements or flex of the closure member 12 in response to external forces are not quickly detected. Examples of such other known actuators are described in U.S. Patent Application No. 2018/0238099, incorporated herein by reference and can include an extendable linkage (e.g., extendable linkage 21 of FIG. 3), moved by a leadscrew, that is driven by an electric motor (e.g., via gearing). Normally, it is desirable for a haptic controlled or power actuator (e.g., actuator 22) to reduce the slack/slop in the actuator to ensure that any sensing at the motor shaft, for example, directly senses motion of the closure member 12. In such other known actuators, the gearing connections and other coupling between the motor shaft and connection to the vehicle body 14 aim to reduce slack or slop. However, gearing of the other known actuators have internal forces resisting motion of the closure member 12, causing delays between detection using a hall sensor (e.g., hall sensor 64 of FIG. 3) measuring rotation of a shaft of an electric motor (responsive to motion of the closure member 12), for example, and haptic/servo assist activation of the other known actuators. One illustrative example of a haptic/servo assist activation is shown and described in US Patent Application Publication No. US20220243521A1 titled “A Power Closure Member Actuation System”, the entire contents of which are incorporated herein by reference. FIG. 2 illustrates a range of angular movement 23 of the closure member 12 between the open position and the closed position and illustrates the amount of the movement of the closure member 12 (indicated with numeral 23) that may be allowed before a sensor of other known actuators detect movement of the closure member 12 by the user. So, the closure member 12 may flex due to the user without imparting a rotation of the closure member 12 about a hinge axis of the hinges 16, 18 causing the extensible member or extendable linkage to extend/retract. This leads to the user possibly sensing motion of the closure member 12 due to flex, so the user may sense resistance by actuator. Thus, due to back drive forces of the actuator, for example, what happens is that the user when they initially move the closure member 12, due to the internal resistance of the actuator, the closure member 12 will flex before the sensor detects motion (e.g., the internal resistance of the actuator is able to hold the extensible member to allow some flex in the closure member 12). This can cause delay in haptic assistance motor control and some abrupt/unnatural assist sensations to a user once the sensor finally detects motion and any force assist control kicks in.

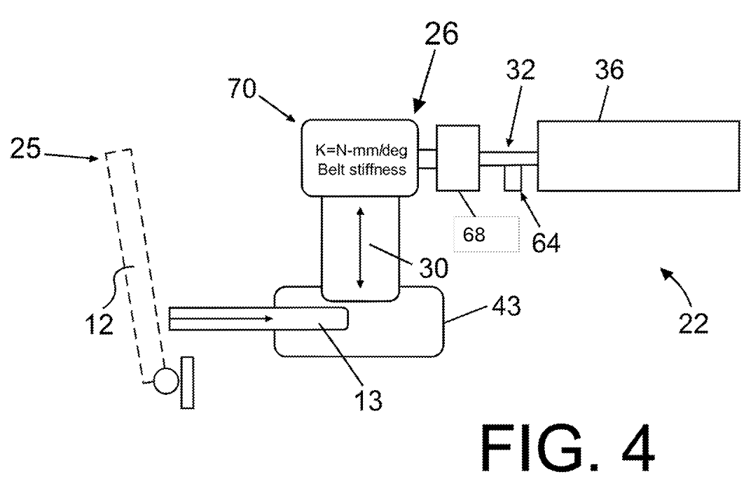

FIG. 3 shows an example actuator 22 that allows movement of the closure member 12 in response to external forces 25 (FIG. 4) to be detected more quickly compared to other known actuators. The actuator 22 of FIG. 3 includes a kinematic chain for converting rotation of an electric motor 36 to cause an extensible member to extend and retract to cause a closure panel to respectively open and close. The kinematic chain coupling the extensible member to the motor, is configuration to a lost motion. As used herein, ‘lost motion’ refers to relative movement permitted by elastic or compliant deformation of the flexible element before movement of the motor is transmitted to the extensible member, and vice versa where movement of the extensible member is transmitted to the motor. Lost motion may also be provided by clearance that is taken up after a limited amount of movement between components, such as for example by a pin and moving in a enlarged slot configuration, gearing having spacing between teething, stretch in a cable, give in plastic components, bend in resilient elements such as springs, or play between connectors and/or levers or other parts and components, as non-limiting examples. The lost motion allows a limited range of motion of an input movement to the kinematic chain before the lost motion is taken up and the input drives the motion of the output. Until the lost motion is taken, up the input may not drive the motion of the output. For example, the source of movement to the input of the kinematic chain may be either from one of the rotation motor or from the motion of the extensible member, that does not produce a proportional or immediate output movement to the other one of the rotation motor or to the motion of the extensible member until the lost motion is taken up.

The actuator 22 of FIG. 3 includes a housing 27 and a drive mechanism 28 operably coupled to the closure member 12. The actuator 22 includes an electric motor 36 for driving the kinematic chain illustratively shown as having the drive mechanism 28 and a flexible element 30. The flexible element 30 is configured to provide the lost motion by allowing flex between a drive shaft 32 of the electric motor 36 and an extensible member 21 of the drive mechanism 28 as the closure member 12 is moved by a user. The drive mechanism 28 and the flexible element 30 illustratively provide the kinematic chain 34 between the extensible member 21 and the motor 36, but may include other intervening components such as a planetary geartrain, additional linkages, and clutches as non-limiting examples. The actuator 22 includes the electric motor 36, the kinematic chain 34 having lost motion, and an internal sensor 64 configured to detect internal motion only after the lost motion is taken up.

Referring back to FIG. 1, the power closure member actuation system 20 additionally includes an external sensor 86 separate from the actuator 22 and coupled to the closure member 12 and configured to detect motion of the closure member 12. According to a specific aspect and as will be detailed below, the external sensor 86 may be a closure member accelerometer 86. External sensor 86 may provided at a location on the closure member accelerometer 86. External sensor 86 may be provided as part of a door control module configured to control other components of the door such as a window regulator and a side mirror and a door latch, or may be provided as part of a door latch, or may be provided as part of the actuator 22. The power closure member actuation system 20 also includes a controller 50 that is coupled to the actuator 22 and in communication with other vehicle systems (e.g., a body control module) and also receives vehicle power from the vehicle 10 (e.g., from a vehicle battery 53). The controller 50 is also in communication with the external sensor 86. The controller 50 is configured to determine the closure member 12 is moved manually by the user using the external sensor 86 including movement enabled by the flex. The controller 50 is also configured to control the actuator 22 to move the closure member 12 based on the movement of the closure member 12 by the user detected by the external sensor 86. External sensor 86 is another sensor than the internal sensor 64.

As above and continuing to refer to FIG. 3, the drive shaft 32 of the electric motor 36 is rotatable about a drive shaft axis 35 and the power closure member actuation system 20 further includes the internal sensor 64 in the actuator 22 and coupled to the drive shaft 32 of the electric motor 36. The internal sensor 64 is in communication with the controller 50 and is configured to detect rotation of the drive shaft 32 (i.e., internal motion of the actuator 22). The internal sensor 64 is configured supply a motion signal to the controller 50, which the controller 50 uses to generate a corresponding motor control signal to be supplied to the electric motor 36 which based on the detected internal motion. Thus, according to other aspects of the disclosure, the controller 50 is further configured to determine the closure member 12 is moved manually by the user using the external sensor 86 and control the actuator 22 to move the closure member 12 temporally prior to detecting the rotation of the drive shaft 32 of the electric motor 36 using the internal sensor 64 in response to the user manually moving the closure member 12. In this manner, the internal sensor 64 detects motion of the motor only after the lost motion has been taken up. So, the controller 50 is configured to detect motion of the closure member 12 using the external sensor 86 on the closure member 12 to control the actuator 22 for moving the closure member 12. The controller 50 is also configured to detect the internal motion of the actuator 22 using the internal sensor 64 in the actuator 22 to control the actuator 22. According to other aspects, the controller 50 is further configured to stop controlling the actuator 22 using the external sensor 86 on the closure member 12 when the internal motion is detected using the internal sensor 64 in the actuator 22. The controller 50 is also configured to start controlling the actuator 22 using the internal sensor 64 in the actuator 22 when the internal motion is detected using the internal sensor 64 in the actuator 22. Upon detection of internal motion by the internal sensor 64, the controller 50 discontinues control based on the external sensor 86 and transitions control to the internal sensor 64.

In more detail and still referring to FIG. 3, the drive mechanism 28 includes a leadscrew 13 extending between a first leadscrew end 38 and a second leadscrew end 40 and rotatable about a leadscrew axis 42 parallel to and spaced from the drive shaft axis 35. The leadscrew 13 defines a leadscrew belt pulley 43 at the first leadscrew end 38 and the leadscrew 13 has external threads 44 defined thereon in a threaded region 46 extending from the leadscrew belt pulley 43 to the second leadscrew end 40. The drive mechanism 28 also includes a nut shown illustratively as a ball nut 48 configured to move along the threaded region 46 of the leadscrew 13 in response to rotation of the leadscrew 13 and including a ball 49 captive and rotatable within the ball nut 48. The ball 49 defines a leadscrew hole 54 therethrough. The ball 49 is annularly disposed about the leadscrew 13 and the leadscrew hole 54 defines internal threads 55 engaging the external threads 44 of the leadscrew 13. The actuator 22 further includes an extendable linkage 21 extending from a first linkage end 57 attached to the ball nut 48 to a second linkage end 59 coupled to the closure member 12. The extendable linkage 21 extends along a linkage axis 65 parallel to and spaced from the leadscrew axis 42. The extendable linkage 21 is linearly movable along the linkage axis 65 to move the closure member 12 in response to the ball nut 48 moving along the leadscrew 13 as the leadscrew 13 is rotated. An end stop 67 is attached to the extendable linkage 21 and is configured to abut the housing 27 to limit axial movement of the extendable linkage 21. A connector 69 is also provided for electrically connecting the actuator 22 to the vehicle 10.

Continuing to refer to FIG. 3, the kinematic chain 34 further includes a planetary gearbox 68 coupled to and driven by the drive shaft 32 of the electric motor 36 and configured to rotate a drive belt pulley 70 about a belt pulley axis 73 parallel to and spaced from the leadscrew axis 42 (and coaxial with the drive shaft axis 35). According to an aspect and as shown, the flexible element 30 is a belt 30 surrounding and extending between the drive belt pulley 70 and the leadscrew belt pulley 43. The belt 30 is configured to cause simultaneous rotation of the leadscrew belt pulley 43 and the drive belt pulley 70 while providing the flex between the drive shaft 32 and the leadscrew 13. The flex in the belt pulley 43 illustratively provides the lost motion. Such a belt drive allows the actuator 22 to be reduced in size. For example, the electric motor 36 can be aligned over the leadscrew 13 and the planetary gearbox 68 includes a planetary gear aligned with the drive shaft axis 35, as opposed to having an offset worm engage a nut tube. So, although this flex in the kinematic chain 34 is ordinarily not desirable, it can be leveraged now to eliminate the flex of the closure member 12 without detection to provide a smooth transition of haptic control. While the flexible element 30 is described herein as a belt, it should be appreciated that the flexible element 30 could be some other type of linkage that allows the flex, such as, but not limited to a spring-loaded or biased member. In other embodiments, the flexible element 30 may be any compliant torque-transmitting element capable of providing lost motion.

Accordingly, the electric motor 36 is operably coupled to the extendable linkage 21. The internal sensor 64 in the actuator 22 is configured to detect motion in the kinematic chain 34 disposed between the extendable linkage 21 and the internal sensor 64. Again, the kinematic chain 34 includes the flexible element 30 configured to flex in response to the user moving the closure member 12 prior to the internal sensor 64 detecting motion of the kinematic chain 34. The external sensor 86 is also configured to detect motion of the closure member corresponding to motion in the kinematic chain 34. Thus, according to aspects of the disclosure, the controller 50 is further configured to detect motion of the kinematic chain 34 using the external sensor 86 temporally prior to detecting motion of the kinematic chain 34 using the internal sensor 64. The controller 50 is also configured to control the electric motor 36 of the actuator 22 using the external sensor 86 prior to the internal sensor 64 detecting motion of the kinematic chain 34. In addition, the controller 50 is configured to stop controlling of the electric motor 36 of the actuator 22 using the external sensor 86 subsequent to the internal sensor 64 detecting motion of the kinematic chain 34. The controller 50 is also configured to start controlling the electric motor 36 of the actuator 22 using the internal sensor 64 subsequent to the internal sensor 64 detecting motion of the kinematic chain 34. Consequently, the flex allows motion of the closure member 12 to be registered by the external sensor 86 on the closure member 12, which is very sensitive to motion of the closure member 12. This flex has a lower resistance than the back drive force of the gearing of the actuator 22. So, a more responsive reaction time is provided before haptic control is activated when using the motion of the closure member 12, and also the user does not have to fight the back drive of the gearing before abrupt motor control kicks in. The closure member 12 also is not caused to flex. Also, drive mechanism 28 with some slack/slop can be used to create some give in the actuator 22 to allow the accelerometer 86 to detect the motion of the closure member 12 before the internal hall sensor 64 detects rotation of the drive shaft 32 of the electric motor 36. An actuation signal generated by the controller 50 is therefore used by the electric motor 36 to control the rotation before the lost motion is taken up, which can provide increased response time in power assist support to a user manually moving the door 12. The accelerometer 86 provides a motion signal to the controller 50 which generates a motor actuation signal to be supplied to and received by the electric motor 36. Thus, the electric motor 36 may receive an actuation signal generated by the controller 50 using the accelerometer signal 86 prior to the lost motion being taken up.

As discussed, the power closure member actuation system 20 includes at least one closure member feedback sensor or internal sensor 64. The internal sensor 64 is used to determine at least one of a position and a speed and an attitude of the closure member. Thus, the at least one closure member feedback sensor 64 detects signals from either the actuator 22 by counting revolutions of the electric motor 36, absolute position of the extensible member 21, or from the door 12 (e.g., an absolute position sensor on a door check as an example) can provide position information to the controller 50. Feedback sensor 64 in communication with controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuity) for detecting movement of a target on the closure member (e.g. on the hinge) or actuator 22 (e.g. on a motor shaft) as examples, and/or may also be software based (e.g. using code and logic for executing a ripple counting algorithm) executed by the controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the controller 50. The controller 50 is configured to determine whether an obstacle is detected using the at least one non-contact obstacle detection sensor 66 (e.g., using a non-contact obstacle detection algorithm) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar-based sensor 66 or to characterize the object as a user or human as compared to an non-human object for example based on determining the reflectivity of the object using a radar based sensor 66 and system. The non-contact obstacle detection system may also be configured to determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

FIG. 4 is a simplified diagram of the actuator 22 of FIG. 3 connected to the closure member 12 while a user applies a force 25 on the closure member 12. Motor cogging and friction forces 26 are illustrated. Flex by the door hinges 16, 18 and vehicle body 14 may also occur. As a result, the force 25 by the user causes the closure member 12 to flex (shown in dashed lines). As shown, the belt 30 also flexes (according to a belt stiffness K) allowing the leadscrew 13 to rotate and the motor shaft 32 of the electric motor 36 to rotate in response to the user applying the force 25 to closure member 12. Accordingly, the force 25 by the user is detected more quickly by the internal sensor 64.

As discussed, the external sensor 86 (such as an accelerometer) is also coupled to the controller 50 for detecting an inclination of the vehicle 10. The vehicle inclination sensor or external sensor 86 outputs an inclination signal corresponding to the inclination of the vehicle 10 and the controller 50 is further configured to receive the inclination signal and adjust the command signal to the actuator 22 accordingly. While the vehicle inclination sensor 86 may be separate from the controller 50, it should be understood that the vehicle inclination sensor 86 may also be integrated in the controller 50 or in another control module, such as, but not limited to the body control module 52.

The controller 50 is further configured to perform at least one of an initial boundary condition check prior to the generation of the command signal to the actuator 22 and an in-process boundary check during the generation of the command signal. Such boundary checks prevent movement of the closure member and operation of the actuator 22 outside a plurality of predetermined operating limits or boundary conditions.

Referring back to FIG. 1, for example, The controller 50 can also be coupled to a vehicle latch 83. In addition, the controller 50 may include or be coupled to a memory device 92 having at least one memory location for storing at least one stored motion control parameter associated with controlling the movement of the closure member (e.g., door 12). The memory device 92 also stores original equipment manufacturer (OEM) modifiable door motion parameters (e.g., door check profiles and pop-out profiles).

The controller 50 is also coupled with the latch 83 that includes a cinch motor (for cinching the closure member 12 into the closed position). The latch 83 also includes a plurality of primary and secondary ratchet position sensors or switches that provide feedback to the controller 50 regarding whether the latch 83 is in a latch primary position or a latch secondary position, for example.

Again, the vehicle inclination sensor 86 (such as an accelerometer or inclinometer) is also coupled to the controller 50 for detecting the inclination of the vehicle 10. The vehicle inclination sensor 86 outputs an inclination signal corresponding to the inclination of the vehicle 10 and the controller 50 is further configured to receive the inclination signal and adjust the command signal to the actuator 22 accordingly. Such adjustment may, for example, include adjusting the motion command such that door 12 moves at the same speed and motion profile as compared to the door 12 being moved as if on a level terrain. As a result, the actuator 22 may move the door 12 such that the motion profile (e.g. speed versus door position) when on an incline is the same as or is tracking to the motion profile as if the vehicle was not on an incline. In other words, the user detects no visual difference in the door motion appearance of speed versus position as when the vehicle 10 is on an incline or not. Or for example accordingly may be adjusting the command signal such that door 12 is moved applying the similar resistance force detected by a user as compared to the door 12 being moved as if on level terrain. As a result, the actuator 22 may move the door 12 such that the force required to move the door 12 by the user when on an incline is the same as the force required by a user to move the door 12 as if the vehicle 10 was not on an incline. In other words, the user experiences the same reactionary resistive force of the door 12 acting against the input force of the user when the vehicle 10 is on an incline or not.

The controller 50 includes a processor or other computing unit 110 in communication with the memory device 92. So, the controller 50 is coupled to the memory device 92 for storing a plurality of powered closure member motion parameters and used by the controller 50 for controlling the movement of the closure member (e.g., door 12). The plurality of powered closure member motion parameters includes a closure member model and a plurality of closure member component profiles. The memory device 92 may also store boundary conditions (e.g., plurality of predetermined operating limits) used for a boundary check to prevent movement of the closure member and operation of the actuator 22 outside a plurality of predetermined operating limits or boundary conditions.

Referring back to FIG. 1, a compass 300 may be connected to the computing unit 110. The compass 300 may be formed as microchip device such as for example Honeywell’s 3-Axis Digital Compass HMC5843, and provided as part of the computing unit 110 in one possible configuration. Otherwise, compass 300 may be mounted at other positions on the door 12. For example, the compass 300 may be mounted on the same printed circuit board as the other electronics forming the computing unit 110. Compass 300 is thus configured to detect the change in orientation of the door 12 relative to a magnetic field, and in particular relative to the magnetic North direction. Compass 300 direction may be read by the computing unit 110 for example after the vehicle has been detected to be in a stationary position prior to changing orientation, such as by detecting when the vehicle has been shifted into Park (P.) when the door 12 is in the door closed position In known power system door system, use of hall counts located in a power door actuator 22 is employed as a means to determine the position of the door. Using a position device such as compass 300 provides a manner to determine the door position that is independent of an absolute position device associated with the powered actuator 22 and a manner to determine door position in the event of power loss while the door 12 is open which causes the power systems lose the detected position of the door angle using the absolute position device. As a result, hall sensors provided in the actuator 22 or on the door hinge 16, 18, for example, are not required, and there is no need to store a position of the door angle in the system memory. Eliminating sensors in the drive unit 22 can provide for a reduction in size of the actuator 22 and the elimination of wiring running into and out of the drive unit 22. When compass 300 is described with reference to detecting a magnetic field to determine a constant reference point of the earth, other compass device types may also be employed not relying on magnetic fields, such as a gyrocompass, to determine a position of the door 12. Still other types of inertia based devices may be employed to determine position of the door 12 without used of external reference inputs. Consequently, the controller 50 is configured to receive one of a motion input associated with a powered assist mode (i.e., assisting a user moving the closure member 12 with some force in response to an ongoing input / force from the user to make it easier for the user to move the closure panel 12) and an automatic mode initiation input associated with an automatic mode (i.e., automatically moving the closure member 12 in response to a one time input from the user). The controller 50 is then configured to send the actuator 22 the command signal based on such a user input (e.g., the motion input or the automatic mode initiation input) and the plurality of powered closure member motion parameters to vary the actuator output force acting on the closure member 12 to move the closure member 12. The controller 50 additionally monitors and analyzes historical operation of the power closure member actuation system 20 and adjusts the plurality of powered closure member motion parameters accordingly.

The controller 50 is configured to receive the automatic mode initiation input and enter the automatic mode to output the command signal in response to receiving the automatic mode initiation input or input motion command. The automatic mode initiation input can be a manual input on the closure member itself or an indirect input to the vehicle (e.g., closure member switch 58 on the closure member, switch on a key fob 60, etc.). So, the automatic mode initiation input may, for example, be a result of a user or operator operating a switch (e.g., the closure member switch 58), making a gesture near the vehicle 10, or possessing a key fob 60 near the vehicle 10, for example. It should also be appreciated that other automatic mode initiation inputs are contemplated, such as, but not limited to a proximity of the user detected by a proximity sensor. Such powered assist mode and automatic mode operation is discussed in U.S. Patent Application No. 2025/0059815, incorporated herein by reference.

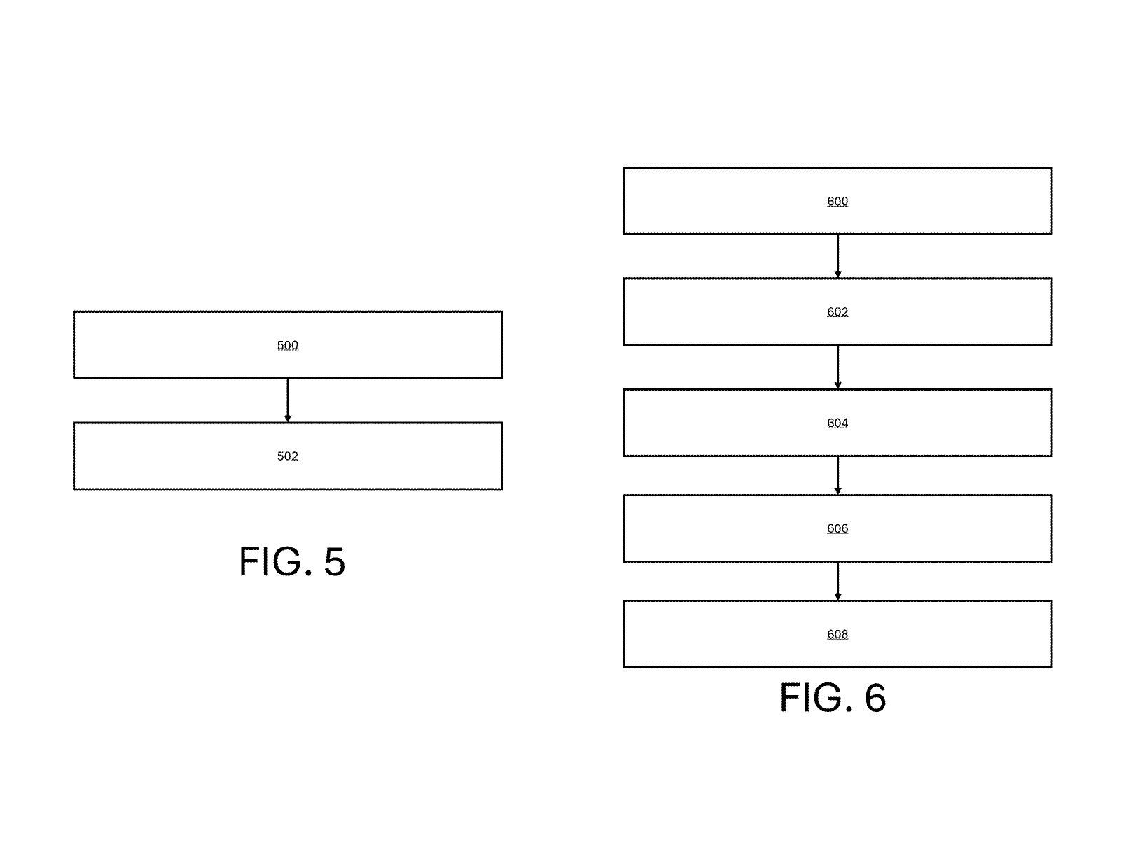

FIGS. 5-7 illustrate steps of a method of controlling movement of a closure member 12 of a vehicle 10 between open and closed positions relative to a vehicle body 14 using a power closure member actuation system 20. Referring initially to FIG. 5 and according to aspects of the disclosure, the method includes the step of 500 using an external sensor 86 on the closure member 12 to detect motion of the closure member 12 to control an actuator 22 for moving the closure member 12. The method also includes the step of 502 using an internal sensor 64 in the actuator 22 to detect internal motion of the actuator 22 to control the actuator 22.

Again, the external sensor 86 can be a closure member accelerometer 86. Thus, referring specifically to FIG. 6 and according to other aspects, the method further includes the step of 600 detecting motion of the closure member 12 using the closure member accelerometer 86 on the closure member 12. Next, 602 controlling the actuator 22 using the closure member accelerometer 86 on the closure member 12. In addition, the method includes the step of 604 detecting internal motion of the actuator 22 using the internal sensor 64 in the actuator 22. The method continues with the step of 606 stopping controlling the actuator 22 using the closure member accelerometer 86 on the closure member 12 when the internal motion is detected using the internal sensor 64 in the actuator 22. The method also includes the step of 608 begin controlling the actuator 22 using the internal sensor 64 in the actuator 22 when the internal motion is detected using the internal sensor 64 in the actuator 22.

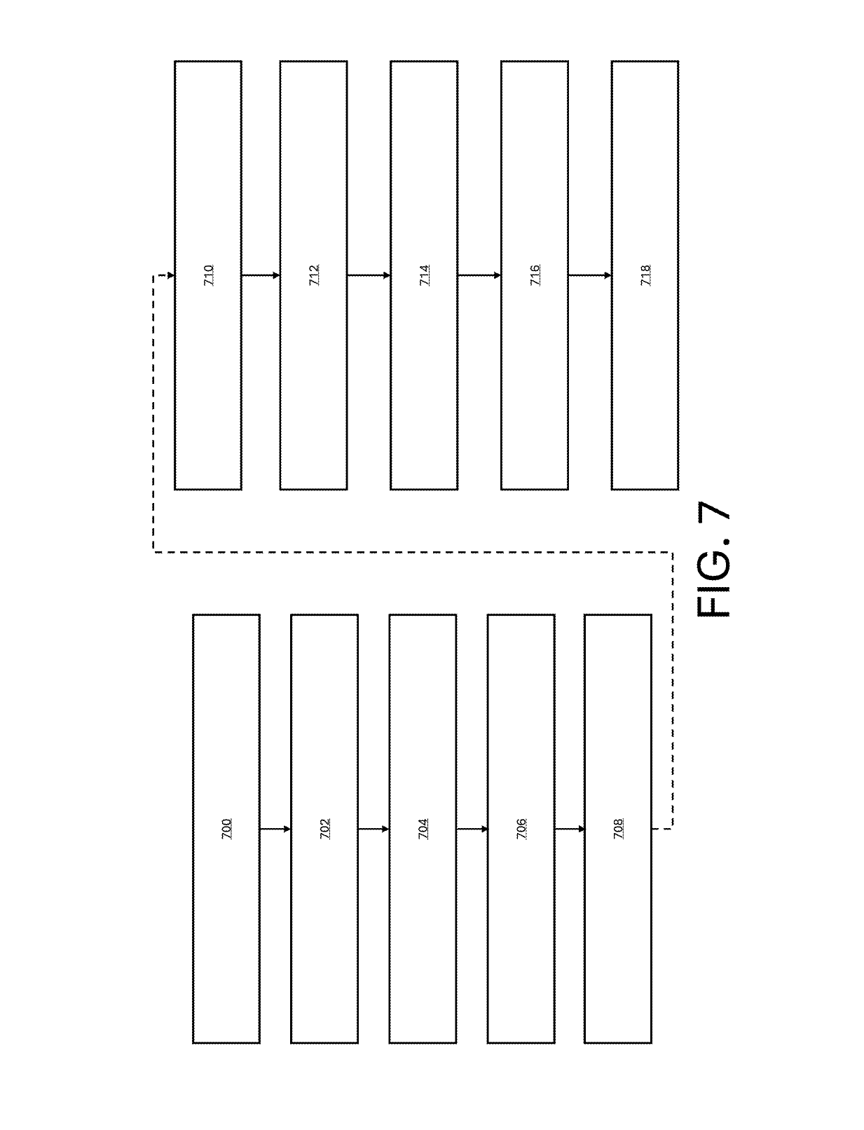

According to another aspect and referring specifically to FIG. 7, the method further includes the step of 700 providing an actuator 22 for the closure member 12 with an extendable linkage 21. Next, 702 providing the internal sensor 64 in the actuator 22. In addition, the method includes the step of 704 providing a kinematic chain 34 between the extendable linkage 21 and the internal sensor 64. The method proceeds with the step of 706 providing a flexible element 30 as part of the kinematic chain 34. The method continues by 708 allowing the flexible element 30 to flex in response to a user moving the closure member 12 prior to the internal sensor 64 detecting motion of the kinematic chain 34. The next step of the method is 710 providing the external sensor 86 external to the actuator 22. The method additionally includes the step of 712 detecting motion of the kinematic chain 34 using the closure member accelerometer 86 temporally prior to detecting motion of the kinematic chain 34 using the internal sensor 64. The method further includes the step of 714 controlling an electric motor 36 of the actuator 22 using the closure member accelerometer 86 prior to the internal sensor 64 detecting motion of the kinematic chain 34. The method proceeds with the step of 716 stopping controlling of the electric motor 36 of the actuator 22 using the closure member accelerometer 86 subsequent to the internal sensor 64 detecting motion of the kinematic chain 34. The method also includes the step of 718 starting controlling the electric motor 36 of the actuator 22 using the internal sensor 64 subsequent to the internal sensor 64 detecting motion of the kinematic chain 34.

According yet another aspect, the method further includes the step of allowing flex between a drive shaft 32 of an electric motor 36 of the actuator 22 and a drive mechanism 28 of the actuator 22 using a flexible element 30 of the actuator 22 as the closure member 12 is moved by a user, the actuator 22 coupled to the closure member 12 and the vehicle body 14 for moving the closure member 12 relative to the vehicle body 14, the drive mechanism 28 and the flexible element 30 comprising a kinematic chain 34. In addition, the method includes the step of determining the closure member 12 is moved manually by the user using the external sensor 86 separate from the actuator 22 including movement enabled by the flex. The method also includes the step of controlling the actuator 22 to move the closure member 12 based on the movement of the closure member 12 by the user detected by the external sensor 86.

Furthermore, according to other aspects of the disclosure, the method can additionally include the step of determining the closure member 12 is moved manually by the user using the external sensor 86 and controlling the actuator 22 to move the closure member 12 temporally prior to detecting rotation of the drive shaft 32 of the electric motor 36 using an internal position sensor in the actuator 22 in response to the user manually moving the closure member 12.

Accordingly, the power closure member actuation system 20 disclosed herein using the actuator 22 including the flexible element 30 provides numerous advantages. The controller 50 anticipates the activation of the haptic control (i.e., control of the actuator 22 in the power assist mode) by looking at accelerations of the closure member 12 even before any rotation of the motor 36 occurs. More specifically, as discussed above, the usage of the belt driven actuator 22 helps in allowing the flex or “system flexibility” that assists in generating detectable accelerations of the closure member 12 by using the G-sensor or external sensor 86 before the electric motor 36 starts its back drive rotation. Thus, the assisted mode may be started at a lower load provided by the user and with more progressive transition making the user experience more pleasant.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element’s or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed isL

1. A power-operated actuator mechanism for moving a closure member of a vehicle between an open position and a closed position relative to a vehicle body, the power closure member actuator comprising:
a motor for extending and retracting an extensible member to move the closure member;
a kinematic chain coupling the extensible member to the motor, the kinematic chain having a lost motion; and
an internal sensor in the actuator configured to detect internal motion of the actuator when the lost motion is taken up;
wherein the lost motion allows the extensible member to move during a manual motion of the closure member before the lost motion is taken up.

2. The power-operated actuator mechanism of claim 1, wherein the internal sensor is configured to detect motion of the motor after the lost motion is taken up.

3. The power-operated actuator mechanism of claim 1, wherein the kinematic chain includes a flexible element providing the lost motion, wherein the flexible element is configured to flex in response to a user manually moving the door.

4. The power-operated actuator mechanism of claim 3, wherein the flexible element is a belt, wherein the lost motion is provided by a flexing the belt.

5. The power-operated actuator mechanism of claim 1, wherein the internal sensor is configured to detect a motion imparted to the closure member by a user manually moving the closure member, wherein the internal sensor is configured to supply a motion signal to a controller, wherein the motor is electrically coupled to the controller and is configured to receive a motor signal from the controller generated using the motion signal.

6. The power-operated actuator mechanism of claim 5, wherein the internal sensor is configured to detect the motion imparted to the closure member by a user manually moving the closure member when the lost motion is taken up.

7. The power-operated actuator mechanism of claim 6, wherein the motor is configured to receive an actuation signal generated by the controller before the lost motion is taken up.

8. The power-operated actuator mechanism of claim 1, wherein the motor is configured to receive an actuation signal generated by a controller before the lost motion is taken up and before the internal sensor detects internal motion.

9. The power-operated actuator mechanism of claim 1, wherein the motor is actuated by an actuation signal generated by a controller before the lost motion is taken up is generated based on the controller receiving another motion signal from an external sensor.

10. The power-operated actuator mechanism of claim 1, wherein the kinematic chain includes:
a nut coupled to the extensible member;
a lead screw in threaded engagement with the nut, the lead screw configured to cause translation of the nut along the lead screw during rotation of the lead screw; and
a flexible belt adapted to rotate the lead screw, the flexible belt coupled to a motor shaft of the motor.

11. A power closure member actuation system for moving a closure member of a vehicle between an open position and a closed position relative to a vehicle body, the power closure member actuation system comprising:
an external sensor disposed on the closure member and configured to detect motion of the closure member;
an actuator for moving the closure member;
an internal sensor in the actuator configured to detect internal motion of the actuator;
a controller in communication with the actuator and the internal sensor and the external sensor, the controller configured to:
detect motion of the closure member using the external sensor on the closure member to control the actuator for moving the closure member, and
detect the internal motion of the actuator using the internal sensor in the actuator to control the actuator.

12. The power closure member actuation system as set forth in claim 11, wherein the controller is further configured to:
stop controlling the actuator using the external sensor on the closure member when the internal motion is detected using the internal sensor in the actuator, and
start controlling the actuator using the internal sensor in the actuator when the internal motion is detected using the internal sensor in the actuator.

13. The power closure member actuation system as set forth in claim 12, wherein the actuator includes an electric motor operably coupled to an extendable linkage, the internal sensor in the actuator is configured to detect motion in a kinematic chain disposed between the extendable linkage and the internal sensor, the kinematic chain includes a flexible element configured to flex in response to a user moving the closure member prior to the internal sensor detecting motion of the kinematic chain, the external sensor is configured to detect motion of the kinematic chain, and the controller is further configured to:
detect motion of the kinematic chain using the external sensor temporally prior to detecting motion of the kinematic chain using the internal sensor;
control the electric motor of the actuator using the external sensor prior to the internal sensor detecting motion of the kinematic chain;
stop controlling of the electric motor of the actuator using the external sensor subsequent to the internal sensor detecting motion of the kinematic chain; and
start controlling the electric motor of the actuator using the internal sensor subsequent to the internal sensor detecting motion of the kinematic chain.

14. A method of controlling movement of a closure member of a vehicle between open and closed positions relative to a vehicle body using a power closure member actuation system, the method comprising:
using an external sensor on the closure member to detect motion of the closure member to control an actuator for moving the closure member; and
using an internal sensor in the actuator to detect internal motion of the actuator to control the actuator.

15. The method as set forth in claim 14, wherein the external sensor is a closure member accelerometer and the method further includes the steps of:
stopping controlling the actuator using the closure member accelerometer on the closure member when the internal motion is detected using the internal sensor in the actuator; and
starting controlling the actuator using the internal sensor in the actuator when the internal motion is detected using the internal sensor in the actuator.

16. The method as set forth in claim 15, further including the steps of:
providing the actuator for the closure member with an extendable linkage;
providing the internal sensor in the actuator;
providing a kinematic chain between the extendable linkage and the internal sensor;
providing a flexible element as part of the kinematic chain;
allowing the flexible element to flex in response to a user moving the closure member prior to the internal sensor detecting motion of the kinematic chain;
providing the external sensor external to the actuator;
detecting motion of the kinematic chain using the closure member accelerometer temporally prior to detecting motion of the kinematic chain using the internal sensor;
controlling an electric motor of the actuator using the closure member accelerometer prior to the internal sensor detecting motion of the kinematic chain;
stopping controlling of the electric motor of the actuator using the closure member accelerometer subsequent to the internal sensor detecting motion of the kinematic chain; and
starting controlling the electric motor of the actuator using the internal sensor subsequent to the internal sensor detecting motion of the kinematic chain.

17. The method as set forth in claim 14, further including the steps of:
allowing flex between a drive shaft of an electric motor of the actuator and a drive mechanism of the actuator using a flexible element of the actuator as the closure member is moved by a user, the actuator coupled to the closure member and the vehicle body for moving the closure member relative to the vehicle body, the drive mechanism and the flexible element comprising a kinematic chain;
determining the closure member is moved manually by the user using the external sensor separate from the actuator including movement enabled by the flex; and
controlling the actuator to move the closure member based on the movement of the closure member by the user detected by the external sensor.

18. The method as set forth in claim 17, further including the step of determining the closure member is moved manually by the user using the external sensor and controlling the actuator to move the closure member temporally prior to detecting rotation
of the drive shaft of the electric motor using an internal position sensor in the actuator in response to the user manually moving the closure member.
